(19) United States
(12) Patent Application Publication
(10) Pub. No.: US 2026/0221352 A1
(43) Pub. Date: Jul. 30, 2026

(54) SWITCHING DEVICE

(71) Applicant: Ellenberger & Poensgen GmbH, Altdorf (DE)

(72) Inventors: Lothar HOFMEISTER, Neumarkt (DE); Stefan HOLBE, Nuernberg (DE); Julian KAISER, Erlangen (DE); Hendrik-Christian KOEPF, Nuernberg (DE)

(73) Assignee: Ellenberger & Poensgen GmbH, Altdorf (DE)

(21) Appl. No.: 19/461,073

(22) Filed: Jan. 27, 2026

(30) Foreign Application Priority Data
Jan. 27, 2025 (DE) 10 2025 102 802.8

(51) Int. Cl. H01H 1/20; H01H 1/30; H01H 3/28; H01H 9/34; H01H 9/44

(52) U.S. Cl. CPC H01H 1/2075; H01H 1/30; H01H 3/28; H01H 9/34; H01H 9/44

(57) ABSTRACT

A switching device comprising a housing, in which a mechanical switch is arranged, which includes a contact bridge, movably supported in an opening direction, which has a moving contact and a connection with a fixed contact. The mechanical switch is designed in such a way that, during a movement of the contact bridge in the opening direction, the moving contact and the fixed contact are moved away from each other, and during a movement of the contact bridge against the opening direction, the fixed contact is approached. The switching device also has an electromechanical drive, which is connected to the contact bridge, and a return spring, with the aid of which a spring force is applied to the contact bridge against the opening direction.

This nonprovisional application claims priority under 35 U.S.C. § 119(a) to German Patent Application No. 10 2025 102 802.8, which was filed in Germany on Jan. 27, 2025, and which is herein incorporated by reference.

### BACKGROUND OF THE INVENTION

### Field of the Invention

The invention relates to a switching device. The switching device comprises a housing, in which a mechanical switch is arranged, which includes a contact bridge movably supported in an opening direction, which has a moving contact and a connection with a fixed contact.

### Description of the Background Art

Circuit-breakers are customarily used to protect an electrical line or a device against a malfunction of the assigned circuit, for example an excessive applied electrical voltage or an excessive flowing electrical current. This occurs, for example, when there is prior damage to the device to be protected or to the electrical line. In this case, an interruption of the current flow takes place with the aid of the circuit-breaker, so that further damage is avoided.

To interrupt the current flow, the circuit-breaker includes a switching device having a switch. To provide a contact protection and for the purpose of easy mounting, the switch is arranged within a housing. The switch is designed, for example, as a semiconductor switch. For structural reasons, it has an inner resistance, for which reason it heats up during operation, at least if a comparatively high electrical current is conducted. A cooling is thus required. An efficiency is also reduced.

In one alternative, the switch is provided with a mechanical design, in which an electrical resistance is reduced. The mechanical switch usually includes a moving contact, which may be positioned in relation to a fixed contact. When they are situated at a distance from each other, the mechanical switch is opened. When the moving contact rests against the fixed contact, the mechanical switch is closed, so that an electrical current flow over the mechanical switch is made possible.

The moving contact is usually impinged upon at least indirectly by a spring, the active spring force being such that the moving contact is moved away from the fixed contact. In order for a desired current conduction to be made possible with the aid of the mechanical switch, a latching mechanism is usually present, which is not released until a certain condition is met, so that the moving contact is moved away from the fixed contact. The latching mechanism is designed, for example, as a bimetal element, over which the electrical current conducted with the aid of the switching device is conducted. In the case of an excessive electrical current, the bimetal element heats up, for which reason the mechanical switch is opened.

In one refinement, an electromechanical drive is also present, which also acts upon the moving contact. It is advantageously designed in such a way that, when current is supplied to the drive, the mechanical switch is placed in an electrically conductive state. The opening takes place, for example, only with the aid of the spring. For example, the mechanical switch is held in the closed state only as long as current is supplied to the drive, which increases safety. In order for a high switching speed to be implemented, it is necessary for a high force to be applied with the aid of the spring, which results in a larger overall size, a more complicated mounting, and a bulky housing.

In one refinement, current is supplied to the drive in the opposite direction for the purpose of opening, so that the moving contact is also moved away from the fixed contact with the aid of the drive. In this case, however, a remagnetization of the drive is necessary, for which reason the force acting upon the moving contact only rises successively. As a result, a comparatively slow opening of the mechanical switch initially takes place. In order to increase the switching speed, a comparatively powerful drive is necessary, for which reason an overall size and manufacturing costs are increased.

### SUMMARY OF THE INVENTION

It is therefore an object of the present invention is to specify a particularly suitable switching device, a switching speed being advantageously increased and/or manufacturing costs reduced.

The switching device can be used, for example, to switch an electrical current, i.e., in particular, to generate and/or interrupt an electrical current flow. For this purpose, the switching device advantageously has two states, namely an electrically conductive state, which is also referred to as the closed state. In this case, it is possible to conduct the electrical current with the aid of the switching device. In the other state, which is referred to as the opened or electrically non-conductive state, in particular, an electrical current flow over the switching device is not possible. For example, the switching device is manually actuated/actuatable, so that the switching device is a manual switch. Alternatively or in combination herewith, it is possible, for example, to actuate the switching device electrically and thus, in particular, remotely. In a further alternative, the switching device is actuated, for example, manually, advantageously depending on certain conditions. The switching device is suitably a constituent part of a circuit-breaker or a contactor.

The circuit-breaker can be used, for example, to protect a device, and the circuit-breaker is, for example, a device circuit-breaker. Alternatively or in combination herewith, the circuit-breaker is used to protect a line and is thus a line circuit-breaker. In particular, the circuit-breaker is used in a DC circuit, for example between a load and a DC voltage source or the like, so that, in particular, a circuit is formed. An electrical DC voltage between 400 V and 650 V, i.e., in particular, a higher DC voltage, is preferably present in the DC circuit. The circuit breaker is preferably used to protect an actuator in an industrial plant. The actuator forms, in particular, the load. The circuit-breaker or at least the switching device is advantageously used in the area of industrial automation. In particular, the electrical voltage switched with the aid of the circuit-breaker/switching device is 24 V, 48 V, 380 V, 650 V, 760 V. In one alternative, the circuit-breaker is used to protect, or at least the switching device is used to switch, a street light system, a ship electrical system, railroad application infrastructure, a railway application drive, or in the area of electrified aeronautics. In a further alternative, the circuit-breaker/switching device is used in the expansion and integration of renewable energy generators in separate networks, in private homes, in greenhouses, in the electrification of road-bound mobility (electromobility), agriculture, or in construction site vehicles. The electrical (DC) voltage used is, for example, between 1,500 V and 3,000 V or is 110 V, 380 V, 400 V, 800 V, 1,000 V, 1,500 V, 3,000 V. In summary, as an alternative to its application in an industrial plant, the circuit-breaker/switching device is used, for example, in an electric vehicle, such as a motor vehicle, an aircraft, or a ship/boat.

In an example, the switching device can be designed as a disconnecting switch or as constituent part thereof, which is also referred to as a disconnector. For example, the switching device comprises a mechanical lever, with the aid of which the switching state of the control device may be changed.

The switching device advantageous can comprise two device connections, to which further components of the circuit may be connected in the mounted state. The device connections are suitable, in particular provided and configured, for this purpose. A cable or a busbar is advantageously connected to the particular device connection for this purpose, a cross-section thereof being between, for example, 10 mm² and 100 mm² or between 25 mm² and 92 mm². The cross-section is, for example, 16 mm², 25 mm², or 35 mm². The cross-section is, for example, 6 mm², between 6 mm² and 16 mm², or between 16 mm² and 50 mm². In particular, the device connections are designed in the manner of cage clamps or at least comprise the latter. The two device connections are advantageously connected to each other electrically with the aid of a current path. For example, the two device connections are electrically contacted directly to each other with the aid of this current path, or a further component is electrically connected in series to the current path, via which and via the current path the two device connections are then electrically connected to each other.

The switching device can include a housing, which is preferably manufactured from a plastic. All other components of the switching device are suitably arranged in the housing. The housing advantageously forms an outer boundary of the switching device. A contact protection is thus provided, and the components are protected against environmental influences. For example, the housing is designed as a single piece, which increases a tightness. Alternatively, the housing is assembled from multiple housing parts. The housing is particularly preferably formed with the aid of two shells set against each other. This makes a mounting easier. The current path is suitably arranged in the housing. The possible device connections are advantageously introduced into the housing, so that an electrical contacting of the current path is made possible from outside the housing.

The switching device can include a mechanical switch, which is arranged in the housing. The mechanical switch advantageously forms a constituent part of the current path. The mechanical switch is thus electrically connected between the two device connection of the switching device. It is therefore possible to switch an electrical current flow over the first current path, using the mechanical switch. For example, the current path also includes further components or, for example, the current path is formed only with the aid of the mechanical switch as well as possible electrical lines, such as busbars, which lead to the mechanical switch. Manufacturing costs are thus reduced.

The mechanical switch can include a contact bridge having a moving contact. For example, the contact bridge comprises a bridge body, to which the moving contact is fastened. For example, the moving contact forms a single piece with the bridge body, or the moving contact and the bridge body are advantageously made from different materials. In particular, the bridge body is manufactured from a copper. For example, the moving contact is permanently soldered, permanently welded, or permanently riveted to the bridge body. In particular, the contact bridge, suitably the possible bridge body, is strip-shaped and thus has a main extension direction. The moving contact is preferably assigned to one of the ends of the contact bridge in the main extension direction. The mechanical switch also includes a connection having a fixed contact. The connection suitably includes a connection body, which is made, for example, from a copper. For example, the fixed contact is made from the same material as one of the connection bodies and is, in particular, formed thereon. However, they are advantageously manufactured from different materials, preferably from a metal. For example, the fixed contact is permanently soldered, permanently welded, or permanently riveted to the connection body.

The connection, or at least the fixed contact, can be held rigidly on the housing, so that a relative movement of the fixed contact with respect to the housing is not possible. The contact bridge is movably supported in an opening direction, in particular with respect to the fixed contact and/or with respect to the housing. It is thus possible to move the contact bridge and therefore also the moving contact. The mechanical switch is designed in such a way that, during a movement of the contact bridge in the opening direction, the moving contact is moved away from the fixed contact. During a movement of the contact bridge against the opening direct, however, the moving contact approaches the fixed contact. It is advantageously possible to place the moving contact against the fixed contact by moving the moving contact against the opening direction, so that a direct mechanical contact exists therebetween. In this state, the mechanical switch is preferably electrically conductive and/or closed. In particular, the movement of the contact bridge against the opening direction is limited by the movement of the moving contact against the fixed contact. During the movement of the contact bridge in the opening direction, however, a movement of the two contacts away from each other takes place, so that, in particular, an air gap is formed therebetween. In this state, the mechanical switch is preferably electrically non-conductive and/or opened. It is therefore possible to change a switching state of the mechanical switch by moving the contact bridge.

The switching device can comprise an electromechanical drive, which is suitably also arranged in the housing. The electromechanical drive is connected to the contact bridge, so that the latter may be adjusted with the aid of the electromechanical drive. The mechanical switch is therefore driven with the aid of the electromechanical drive. This makes it possible to change the switching state of the mechanical switch by operating the drive.

The switching device furthermore can comprise a return spring. With the aid thereof, a spring force is applied to the contact bridge against the opening direction. The return spring is thus arranged and/or designed in such a way that the spring force is applied to the contact bridge, the spring force being directed against the opening direction. For example, the return spring mechanically rests against the contact bridge directly or via further constituent parts. The switching device is advantageously designed in such a way that the mechanical switch is closed with the aid of the return spring, in particular, when the drive is not being operated and/or the contact bridge is not blocked, i.e., a movement of the contact bridge is, in principle, made possible. For example, the spring force is applied to the contact bridge against the opening direction with the aid of the return spring in each location/position of the contact bridge, or at least until the moving contact rests against the fixed contact. In this case as well, however, the provision of the spring force advantageously takes place so that an unintentional release of the moving contact from the fixed contact is prevented. The return spring is particularly preferably situated on the side of the contact bridge opposite the electromechanical drive, which is also referred to, in particular, only as the drive. The contact bridge is thus advantageously arranged between the return spring and the drive in the opening direction, so that a comparatively large amount of mounting space is provided for the drive and the return spring. In particular, the return spring is designed in the manner of a helical spring.

Due to a design of this type, a closing of the mechanical switch thus takes place with the aid of the return spring, while the opening of the mechanical switch advantageously takes place with the aid of the electromechanical drive, which is suitably designed for this purpose. In other words, it is thus possible to overcome the spring force by operating the electromechanical drive, so that a movement of the moving contact away from the fixed contact takes place. Due to the return spring, the force needed to initially move the moving contact away from the fixed contact is comparatively low at first and increases along with the increasing distance of the moving contact from the fixed contact. At the start of operating the drive, a comparatively fast movement of the contact bridge thus takes place, for which reason a switching speed is increased. Since it is not necessary to keep the mechanical switch in the electrically conductive state by supplying current to the electromechanical drive, no remagnetization is needed at the beginning of the opening movement of the mechanical switch, for which reason a comparatively high force is applied to the contact bridge with the aid of the electromechanical drive essentially immediately after the start of the current supply, which is why the contact bridge is comparatively rapidly accelerated. The switching speed is also increased for this reason. In addition, the spring force needed to keep the mechanical switch in the electrically conductive state and/or to place it into this state is comparatively low, for which reason the return spring may be provided with a comparatively compact design. It is therefore not necessary to make the other constituent parts of the switching device comparatively robust, for which reason the manufacturing costs, material costs, and overall size are reduced. It is furthermore only necessary to overcome the comparatively low spring force with the aid of the drive, for which reason power requirements therefor are reduced. An overall size and manufacturing costs are thus also reduced for this reason.

For example, the opening direction can be curved. However, the opening direction can be preferably in a straight line. The opening direction is, in particular, perpendicular to the extension of the contact bridge. A construction is thus simplified. For example, the mechanical switch comprises only a single moving contact. However, the mechanical switch particularly preferably includes a further moving contact, which is preferably also a constituent part of the contact bridge. A further fixed contact, which is, in particular, a constituent part of a further connection, is assigned to the further moving contact. The two moving contacts, the two fixed contacts, and/or the two connections are advantageously of the same design. The mechanical switch is advantageously designed in such a way that the two moving contacts rest against the fixed contact assigned in each case when the mechanical switch is in the electrically conducting (conductive) state. Each moving contact is then moved away from the fixed contact assigned in each case by moving the contact bridge. The mechanical switch is therefore suitably designed in the manner of a double interrupter, for which reason the electrical voltage present between each fixed contact and the assigned moving contact is reduced in the opened (switching) state of the mechanical switch. As a result, a formation of an arc is prevented there, or this only takes place if a comparatively high electrical voltage is present.

An arc chute can be assigned to the fixed contact and the moving contact. In particular, an extinguishing of an arc formed therebetween takes place with the aid of the arc chute when the mechanical switch is opened. The arc chute advantageously comprises multiple quenching plates or the like for this purpose. These are made from a metal and/or a ceramic. If the two moving contacts and the two fixed contacts are present, two corresponding arc chutes are preferably present.

The arc chute preferably can also comprise a blowout arrangement, such as a permanent magnet and/or a steel core. The blowout arrangement preferably comprises one or multiple blowout plates, between which the quenching plates are arranged. A magnetic field is provided with the aid of the blowout arrangement, so that the Lorentz force, based on which the arc is driven between the quenching plates, acts upon to the arc present between the moving contact and the fixed contact.

For example, the switching device can comprise only the mechanical switch. However, the switching device particularly preferably also comprises a semiconductor switch, which is designed, for example, as a field-effect transistor, such as a MOSFET or as an IGBT or a GTO. The semiconductor switch can be electrically connected in series to the mechanical switch. This makes it possible to first interrupt the electrical current with the aid of the semiconductor switch and to subsequently open the mechanical switch. The formation of an arc is thus avoided, a galvanic isolation nevertheless taking place. Alternatively, for example, the semiconductor switch is electrically connected in parallel to the mechanical switch. When the mechanical switch is opened, an arc, however, being formed there, it is possible to briefly place the semiconductor switch into the electrically conductive state. As a result, the arc collapses, so that the electrical current flow over the mechanical switch is interrupted. The semiconductor switch is then placed again into the electrically non-conductive state. In this case, the arc does not form again, and the electrical current is interrupted. Alternatively, the semiconductor switch is placed into the electrically conductive state prior to opening the mechanical switch. If the mechanical switch is then placed into the electrically non-conductive state, i.e., is opened, the electrical current is conducted with the aid of the semiconductor switch, for which reason no arc is formed in the mechanical switch. Afterwards, the semiconductor switch is also placed into the non-conductive state, so that electrical current is no longer conducted over the switching device.

For example, the return spring can be supported on a component of the switching device, which is also movably supported. The moving component is driven, for example, with the aid of the drive. The mechanical switch advantageously comprises a contact bridge carrier, to which the contact bridge is connected. The electromechanical drive is advantageously connected to the contact bridge, so that the latter may be moved with the aid of the drive. The drive is thus connected to the contact bridge via the contact bridge carrier. For example, the contact bridge is rigidly held on the contact bridge carrier. However, the contact bridge is preferably movably supported on the contact bridge carrier, advantageously in the opening direction. It is thus also possible to be able to move the contact bridge relative to the contact bridge carrier at least to a certain extent in the opening position or against the opening position. The return spring is suitably supported on the contact bridge carrier and the contact bridge. It is therefore possible to adjust the contact bridge carrier with the aid of the drive, the contact bridge being able to be adjusted against the opening position relative to the contact bridge carrier with the aid of the return spring, at least to a limited extent, namely within the scope of the support on the contact bridge carrier.

However, the return spring can be supported on the housing. For example, the return spring is supported directly on the housing, for which the housing advantageously has a correspondingly designed location. Alternatively the return spring is supported indirectly on the housing via a further component, which makes mounting easier. Due to the support, an end of the return spring is at least held relative to the housing in a stationary manner, so that the spring force acting upon the contact bridge may be comparatively easily determined. An unpredictable behavior of the switching device may also be avoided.

For example, it is possible to change the switching state of the mechanical switch in both directions, i.e., to place them in the electrically conductive state as well as in the electrically non-conductive state. In particular, it is possible to also apply a force to the contact bridge against the opening direction with the aid of the drive. A functionality is thus increased. However, the electromechanical drive is particularly preferably designed in such a way that, with the aid thereof, a force may be applied to the contact bridge only in the opening direction. A construction is thus simplified. Manufacturing costs are also reduced. In particular, the electromechanical drive is also supplied with current with the aid of the electrical current conducted over the possible current path. The electromechanical drive is suitably electrically connected in parallel to the mechanical switch. A rectifier is advantageously arranged between the electromechanical drive and the mechanical switch/current path. As a result, the possible electrical current flows through the electromechanical drive in only one direction. Due to a design of this type, the construction is simplified, and no control unit, for example, is necessary to operate the drive. However, it is only possible to apply a force in one direction with the aid of the drive, the opening direction being selected. When supplying current to the electromechanical drive, the force is thus applied in the opening direction. If current is not supplied to the drive, a force is applied, for example, thereby to the contact bridge against the opening direction.

The contact bridge carrier can be particularly preferably present, on which the contact bridge is movably supported. Due to the support on the contact bridge carrier, a removal of the contact bridge from the contact bridge carrier is advantageously not possible. The contact bridge is preferably captively connected to the contact bridge carrier, and/or it may be moved, in particular, in the opening direction relative to the contact bridge carrier only between two end positions. The electromechanical drive is preferably connected to the contact bridge carrier, so that the electromechanical drive is connected to the contact bridge via the contact bridge carrier. A possible force is applied to the contact bridge carrier and forwarded therefrom to the contact bridge with the aid of the drive. An adjustment of the contact bridge is thus also still made possible. It is possible to adjust the position of the contact bridge at least to a limited extent, independently of the mechanical drive, for which reason a flexibility is increased. The contact bridge carrier is advantageously manufactured from a plastic. Due to a design of this type, the connection to the electromechanical drive is made easier. The contact bridge is advantageously electrically isolated from further constituent parts of the mechanical switch/switching device, due to the contact bridge carrier.

For example, the return spring can be supported on the contact bridge. If the return spring is also supported on the contact bridge carrier, it acts in the manner of a contact pressure spring. With the aid of the return spring, this ensures that a possible burn-off of the moving contact/fixed contact is compensated for. However, the return spring is particularly preferably supported on the housing in this case. The contact bridge carrier advantageously comprises a corresponding cavity, through which the return spring is guided. In a design of this type, it is possible, for example, to move the contact bridge carrier in the opening direction by supplying current to the drive, the contact bridge remaining in the original position, in which the moving contact rests against the fixed contact, due to the return spring, Upon reaching the end of the movable support of the contact bridge on the contact bridge carrier, the contact bridge is then carried along by the contact bridge carrier and is also moved. In this case, the contact bridge carrier may be accelerated to a comparatively high speed with the aid of the drive, so that the contact bridge moves comparatively rapidly right from the start, and the moving contact is moved away from the fixed contact. A switching speed is thus further increased.

Further, for example, the return spring can be supported on the contact bridge carrier. The contact bridge carrier is thus moved or at least may be moved in each case with the aid of the drive as well as with the aid of the return spring. The return spring is advantageously also supported on the housing. The electrical isolation of the contact bridge with respect to further constituent parts of the switching device is simplified, due to the contact bridge carrier. The contact bridge is preferably supported on the contact bridge carrier by its contact pressure spring. An uncontrolled movement of the contact bridge relative to the contact bridge carrier is thus avoided. For example, a force is applied to the contact bridge in the opening direction with the aid of the contact pressure spring. However, a force is particularly preferably applied against the opening direction with the aid of the contact pressure spring. As a result, it is ensured with the aid of the contact pressure spring that the moving contact rests against the fixed contact, if this is desirable, i.e., in particular, even if the switching device is subjected to shocks. The return spring and the (electromechanical) drive are thus used only to move the contact bridge carrier, for which reason, in particular, the switching state of the mechanical switch is changed and/or predefined thereby. The contact pressure spring and the movable support of the contact bridge on the contact bridge carrier in the opening direction are used to compensate for a burn-off or other wear of the moving contact and/or fixed contact, for which reason the switching device may be used over a comparatively long period of time.

For example, the electromechanical drive can be fastened directly to the contact bridge carrier. A number of necessary components is thus reduced. However, the electromechanical drive is particularly preferably fastened to a slide. The slide and the contact bridge carrier, in turn, are inserted into each other. In other words, the slide and the contact bridge carrier are different components, which, however, are inserted into each other. As a result, it is possible to move the contact bridge carrier with the aid of the slide. For example, the contact bridge carrier is inserted into the slide, or the slide is advantageously inserted into the contact bridge carrier. The contact bridge carrier preferably has a suitable receptacle for this purpose. Due to the slide, it is possible to manufacture the latter and the contact bridge carrier from different materials, which makes it possible to flexibly adapt the switching device. It is thus possible, in particular, to manufacture the contact bridge carrier from an electrically isolating material, such as a plastic, while the slide, for example, is manufactured from a metal. A short-circuit with the contact bridge is nevertheless avoided, due to the contact bridge carrier. It is furthermore possible to manufacture the drive, to which the slide is fastened, and the mechanical switch, including the contact bridge, which is supported on the contact bridge carrier, separately from each other. This makes a manufacturing easier. It is also possible to produce, for example, different drives and different mechanical switches, which are then coupled to each other with the aid of the slide and the contact bridge carrier. It is possible to use one of the drives with different mechanical switches and vice-versa. An adaptation of the switching device to the particular application is thus made possible, and it is not necessary to keep a multiplicity of different components on hand. In other words, the switching device is designed to be modular, at least in part, which reduces manufacturing costs and increases a flexibility.

The slide and contact bridge carrier can be inserted into each other in the opening direction. They are inserted into each other when mounting the switching device, for which purpose the drive is to be moved onto the mechanical switch in the opening direction until the slide is inserted into the contact bridge carrier or vice-versa. The space needed for this purpose is comparatively small, so that this may also take place in the comparatively tight space of the housing. This simplifies the manufacturing.

For example, the slide and the contact bridge carrier can be fastened to each other. The slide and the contact bridge carrier are, for example, glued or welded to each other. Alternatively, the contact bridge carrier and the slide are latched to each other, so that no additional materials or tools are necessary, for which reason the mounting is simplified and may take place even in tight spaces. However, the slide and the contact bridge carrier are preferably inserted into each other only loosely. By loosely inserting them into each other, it is advantageously possible to only move the contact bridge carrier in the opening direction with the aid of the drive, at least by supplying current the drive. When moving the electromechanical drive against the opening direction, in particular, it is not possible to transfer force to the contact bridge carrier, due to the loose interconnection. They nevertheless advantageously remain inserted into each other, the extension of the component formed in this way, however, being enlarged. The moving back of the contact bridge carrier advantageously takes place with the aid of the return spring. Due to this loose interconnection, it is thus possible to move the contact bridge carrier, and therefore also the contact bridge, partially independently of the drive or to leave it in a corresponding position. The slide and the contact bridge carrier particularly preferably each have an opening, which are congruent to each other when these components are inserted into each other. The opening suitably runs perpendicularly to the opening direction. It is thus possible to fasten the slide and the contact bridge carrier to each other, if this is desired, by inserting an object such as a wire or a rod. To implement the loose connection, on the other hand, the rod/wire is removed. A flexibility in configuring the switching device for different applications is thus increased.

The contact bridge can include the moving contact and the further moving contact. The fixed contact and the further fixed contact are also advantageously present. The contact bridge advantageously protrudes over the contact bridge carrier on both sides perpendicularly to the opening direction, forming a particular projection. One of the projections includes the moving contact and the other projection includes the further moving contact. The contact bridge carrier is thus arranged between the moving contacts. The contact bridge carrier is preferably situated centrally between the two moving contacts, so that a tilting or tipping of the contact bridge is avoided during a movement of the contact bridge carrier.

The switching device, in particular the mechanical switch, particularly preferably comprises two flux guide plates, which are manufactured, in particular, from a ferromagnetic material, advantageously iron. The flux guide plates are arranged in parallel to the opening direction and preferably in parallel to the contact bridge, which essentially has, in particular, a main extension direction. Arranged between the flux guide plates are the moving contacts, and advantageously the complete contact bridge. If the mechanical switch is now opened, and a particular arc forms between each moving contact and the assigned fixed contact, a magnetic field is effectuated thereby. The magnetic field lines are formed with the aid of the flux guide plates in such a way that they pass around the two arcs and do not pass between them. A concentration of the magnetic field lines thus takes place, for which reason the Lorentz force, which then acts upon the particular arcs, is intensified. In particular, the time period until they are driven into the possible arc chute is thus shortened. In particular, the arc chutes each have the blowout plates, the blowout plates being assigned to only one of the two arcs, i.e., the combination of one of the moving contacts and the assigned fixed contact in each case, compared to the flux guide plates.

The electromechanical drive advantageously can have an electrical coil, which is suitably held in a stationary manner. In other words, the electrical coil is particularly preferably rigidly fastened to the housing, for example directly or via additional components. Current was supplied to the electrical coil during the operation of the electromechanical drive. The electromechanical drive further comprises an armature. The latter is designed as or comprises a permanent magnet. Alternatively, the armature advantageously comprises a ferromagnetic component. The armature is suitably supported in a movable manner. The armature is preferably supported along the axis of the electrical coil. For example, the armature is surrounded peripherally by the electrical coil or is offset therefrom along the axis thereof. The electromechanical drive is preferably designed in such a way that the armature is moved along the axis of the electrical coil during the operation of the drive, i.e., in particular, when current is supplied to the electrical coil.

The armature can be connected to the contact bridge, for example rigidly fastened thereto. It is possible at least to apply the force to the contact bridge with the aid of the armature, so that an operative connection at least temporarily or partially exists between the armature and the contact bridge. The armature is preferably supported such that it is movable in parallel to the opening direction, and the opening direction is advantageously in parallel to the axis of the electrical coil, which simplifies a construction. The contact bridge advantageously rests on the axis of the electrical coil.

For example, the electromechanical drive can comprise only a single electrical coil. Alternatively, the electromechanical drive comprises multiple electrical coils of this type, so that the force provided with the aid of the drive is increased. The electromechanical drive is designed, for example, as a moving magnet actuator. The armature, which is movably supported, is also assigned to the moving magnet actuator. In addition, the moving magnet actuator includes a drive unit having the or multiple electrical coil(s), to which current is supplied during the actuation of the drive, so that a magnetic interaction takes place between them and the armature. The electrical coils are held in a stationary manner. Since the electrical coil(s) is/are held in a stationary manner, a construction is simplified, and, with the except of the components needed for the support, no further movable components or electrical connections are needed between the movable components, namely the armature, and the stationary components of the moving magnet actuator. A friction of the moving magnet actuator, which is also referred to in the following only as the actuator, is thus also reduced.

The drive unit can comprise two electrical coils, which are, for example, of the same design. However, the two electrical coils are at least offset from each other along a longitudinal axis and arranged concentrically thereto. The armature is situated, in particular, on the longitudinal axis and is supported such that it is movable along the latter. In a switching state of the mechanical switch, the armature is situated in an air gap present between the two electrical coils, where it is held, for example, with the aid of a magnetic shorting plate. In the other switching state, however, the armature is offset along the longitudinal axis, on which, in particular, the axes of the electrical coils are situated.

Since the number of movable constituent parts of the moving magnet actuator, in particular only the actuator, is comparatively small, and they have, in particular, a comparatively low weight, a dynamic of the actuator is comparatively high. An inertia is thus reduced during the actuation of the mechanical switch. As a result, a comparatively rapid switching is made possible with the aid of the switching device.

The electromechanical drive can have two stops, between which the armature may be moved. For example, the movement of the armature is limited with the aid of the stops, and the armature rests against one of the stops in one switching state of the mechanical switch and/or against the remaining stop in the other switching state. In summary, it is possible, for example, to move the armature up to the stops. Alternative, this is made possible, for example, only up to a particular distance at one or both stops. The armature is preferably arranged at least between the two stops in the opening direction. Due to the stops, an uncontrolled movement of the armature is thus avoided, which could result, for example, in a limiting of the functionality of the drive. For example, the two ends of the electrical coils are covered with the aid of the two stops, or, in particular, a gap is particularly preferably formed in each case between the ends of the coil and the stops.

The two stops can be, for example, of the same design, for which reason equivalent parts may be used. Manufacturing costs are thus reduced. However, the two stops are particularly preferably manufactured from materials having different magnetic properties. The stops are made, for example, from the same chemical material, but they have a different thickness or other different designs, so that the magnetic properties of the stops differ. However, the two stops are particularly preferably manufactured from different chemical materials. For example, one of the stops is manufactured from a ferromagnetic material and the other stop from a paramagnetic or diamagnetic material. One of the stops is advantageously made from an iron and the other from a plastic. In particular, the design of the drive is independent of the design and/or the presence of the return spring. Instead, the switching device having a drive of this type is viewed as an independent invention.

With the aid of the stops, it is possible to suitably form the field lines provided with the aid of the electrical coil, for which reason the interaction between the armature and the electrical coil may be improved, thus increasing an efficiency. It is also possible to provide an additional interaction with the armature, namely between one or both stops and the armature, which comprises, in particular, the permanent magnet. This interaction also exists if no current is supplied to the electrical coil, and therefore the drive. As a result, setting the force provided with the aid of the drive is made possible with the aid of the stops, even if no current is supplied to the drive. A flexibility is thus further increased. For example, the force acting upon the contact bridge is also influenced in this way when current is supplied to the electrical coil.

It is thus possible to provide the (electromechanical) drive with a monostable or bistable design. it is also possible to design the electrical coil in such a way that Orly a comparatively low force is provided thereby when current is supplied thereto. The other portion of the force of the drive acting upon the contact bridge is then provided by the interaction of the drive with one or both stops. Manufacturing costs and/or operating costs are thus further reduced.

For example, the force acting between the armature and the stops results in an intensification of the spring force, so that the force is also applied to the contact bridge against the opening directly with the aid of the drive when no current is supplied to the electrical coil. For example, the return spring is designed in such a way that it is relaxed when the moving contact rests against the fixed contact. In this state, due to the interaction with one of the stops, the armature is advantageously held against the latter, and they advantageously rest against each other. When supplying current to the electrical coil, after an initial movement of the armature away from this stop, the force acting therebetween decreases, so that the contact bridge continues to be able to move comparatively rapidly. The interaction between the armature and the stop is thus used to hold the mechanical switch in the closed state, the return spring then advantageously being relaxed.

The switching device can be designed in such a way that a compensation force acting against the spring force acts upon the contact bridge, due to the interaction of the armature with the stop(s). To provide the combination force, the stops of the drive are advantageously designed and/or positioned accordingly. For this purpose, in particular, a distance of the stops between the armature and the electrical coil is suitably selected. For example, the absolute value of the compensation force is equal to the absolute value of the spring force, or the compensation force is advantageously less than the spring force. At least a portion of the spring force is compensated for by means of the compensation force. As a result, the force to be provided by means of the electrical coil is reduced in order to move the contact bridge. It is thus possible to provide the electrical coil with a comparative compact design, and/or the switching speed is further increased due to the additionally active compression force.

When the moving contact is moved away from the fixed contact, the compensation force advantageously increases, since the armature is also moved between the stops. The switching device, in particular the drive, is preferably designed accordingly. During this movement, the spring force preferably increases, and the difference between the spring force and the compensation force is suitably always the same, regardless of the position of the contact bridge. The switching device is advantageously designed accordingly. An essentially uniform movement or acceleration of the contact bridge therefore takes place.

In summary, the requirements of the return spring used are reduced, due to the interaction between the armature and the stops. A supply of current to the electromechanical drive is not necessary as long as the mechanical switch is closed. To open the mechanical switch, no remagnetization is also necessary, for which reason a switching speed continues to be comparatively high.

The invention further relates to a circuit-breaker having a switching device of this type. The circuit-breaker is used, in particular, to interrupt an electrical current when a fault is present, for example an overcurrent and/or a short-circuit current. Alternatively or in combination therewith, the electrical current flow is interrupted with the aid of the circuit-breaker when an existing electrical voltage is excessive or if the presence of an arc was detected. The circuit-breaker advantageously includes a sensor for this purpose, with the aid of which, in particular, the possible fault may be detected. The sensor is suitably used to detect a state of the circuit-breaker and/or of the electrical current conducted with the aid of the circuit-breaker. Multiple corresponding sensors are advantageously present, so that a comparatively accurate determination of different faults is made possible. For example, one of the sensors is designed as a voltage sensor and the other as a current sensor.

The circuit-breaker can comprise a control unit, which is connected via signals to the sensor. The switching device is actuated with the aid of the control unit, preferably as a function of measurement data captured with the aid of the sensor, and/or if the fault was detected. For this purpose, the measurement data provided with the aid of the sensors are advantageously evaluated with the aid of the control unit. If the fault is present, in particular, the mechanical switch is opened with the aid of the control unit and thus placed in the non-conductive state. In particular, current is supplied to the drive accordingly.

The refinements and advantages explained in connection with the switching device are to be similarly transferred to the circuit breaker as well as to each other and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a DC circuit having a load and a circuit-breaker, which comprises a switching device;

FIGS. 2 and 3 show a perspective view and a sectional representation, respectively, of the circuit-breaker, including the switching device, which comprises a contact bridge movably supported on a contact bridge carrier;

FIGS. 4 and 5 show the contact bridge movably supported on the contact bridge carrier in a sectional representation and perspective view, respectively;

FIG. 6 shows an example of the contact bridge movably supported on the contact bridge carrier in a sectional representation;

FIGS. 7 and 8 show a perspective view of the switching device, different components being omitted in each case; and

FIG. 9 shows a sectional representation of a electromechanical drive of the switching device.

### DETAILED DESCRIPTION

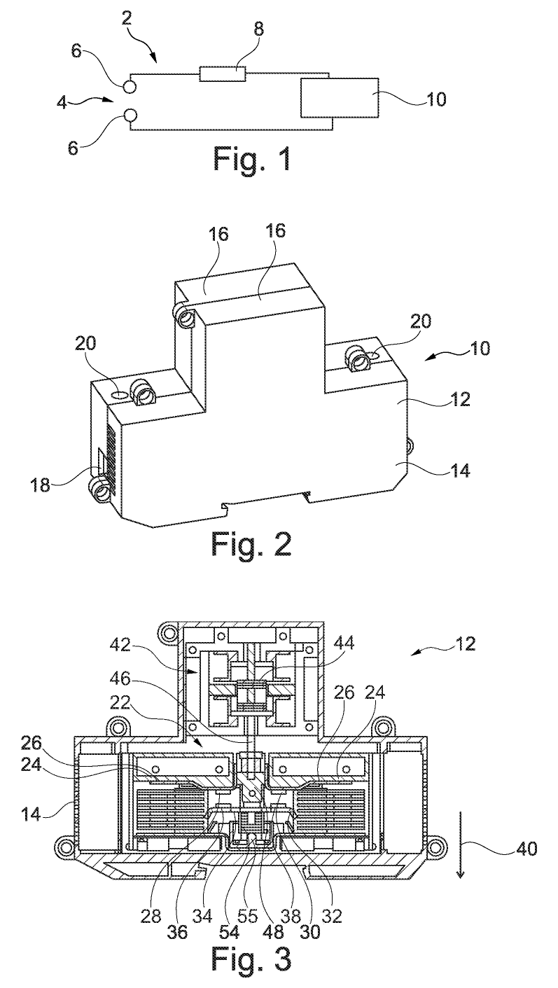

FIG. 1 shows a schematically simplified view of a DC circuit 2, which comprises a DC voltage source 4. An electrical DC voltage of 650 V is provided with the aid thereof, which is present between poles 6 of DC voltage source 4. Load 8 is electrically connected directly to one of poles 6 and via a circuit-breaker 10 to the other one. A circuit is thus formed.

FIG. 2 shows a perspective view of circuit-breaker 10, which comprises a switching device 12. Switching device 12 has a housing 14 with two housing halves 16, which are joined together and are manufactured from a plastic. Two openings are introduced into housing 14, within each of which a device connection 18 is arranged. The connection of an electrical cable leading to DC voltage sources 4 and load 8, respectively, is made possible here. Device connections 18 each have clamping screws, which are not illustrated in greater detail and which are accessible through a mounting opening 20 of housing 14. The cable assigned to particular device connection 18 is clamped and therefore electrically contacted by screwing in the clamping screws.

Switching device 12 is illustrated in a sectional representation in FIG. 3. It has a mechanical switch 22, which is arranged within housing 14 and comprises two connections 24, which are situated at a distance from each other. Connections 24 each comprise a connection body 26, which is designed as a busbar and is made from a tin-plated copper. The two connection bodies 26 are essentially arranged in a shared plane, and each connection body 26 is electrically connected to one of device connections 18 by means of a cable, which is not illustrated in greater detail. A fixed contact 28 is permanently welded to one of connection bodies 26 and a further fixed contact 30 to the other, which are made from a comparatively burn-off-resistant and electrically conductive material.

Mechanical switch 22 also includes a contact bridge 32, which comprises an essentially strip-shaped bridge body 34, which is also made from a tin-plated copper. A moving contact 36 and a further moving contact 38 are welded to bridge body 34, which are made from the same material as the two fixed contacts 28, 30. Contact bridge 32 is movably supported in an opening direction 40, which is essentially perpendicular to the extension of bridge body 34. It is possible to move bridge body 34 in and against opening direction 40. During a movement in opening direction 40, moving contacts 36, 38 are moved away from fixed contacts 28, 30. During a movement in the opposite direction, however, it is possible to mechanically place moving contact 36 against fixed contact 28 and further moving contact 38 against further fixed contact 30. A further movement of contact bridge 32 against opening direction 40 is then prevented, due to the contact. If the mechanical contact is established, the two device connections 28 are connected in an electrically conductive manner with the aid of mechanical switch 22, which is then closed. However, if contact bridge 32 is moved in opening direction 40 and the mechanical contact between moving contacts 36, 38 and fixed contacts 28, 30 is released, mechanical switch 22 is opened, and the two device connections 18 are galvanically isolated from each other.

Switching device 12 also has an electromechanical drive 42, which is likewise arranged in housing 14. Electromechanical drive 42, which is also referred only as drive 42, is operated with the aid of a control unit, which is not illustrated in greater detail, of circuit-breaker 10, which is also arranged in housing 14. The control unit is connected via signals to a sensor, which is not illustrated in greater detail and with the aid of which the electrical current conducted by means of switching device 12 may be characterized and/or detected. Electromechanical drive 42 is operated as a function of measurement data detected with the aid of the sensor.

Drive 42 includes an armature 44, which is movably supported in opening direction 40. Armature 44 is fastened to a fastening rod 46 arranged in parallel to opening direction 40, which, in turn, is rigidly connected to a slide 48 on an end side. Slide 48 and fastening rod 46 are made from a metal, so that they are comparatively robust.

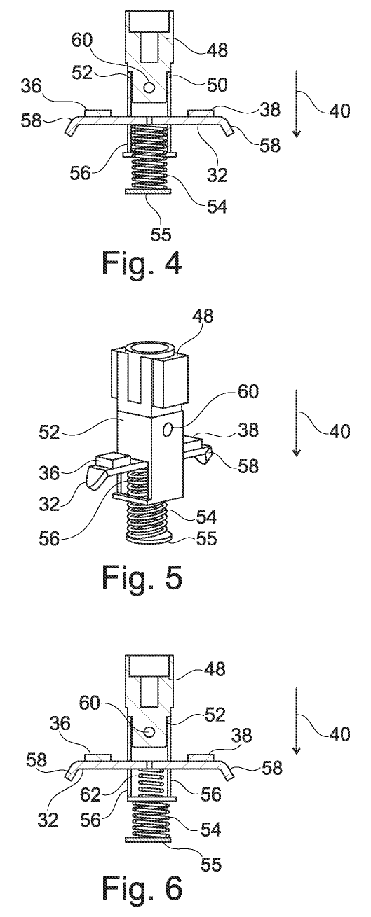

Slide 48, which is also illustrated in an enlargement along opening direction 40 in the sectional representation in FIG. 4 and in a perspective view in FIG. 5, is inserted into a receptacle 50 of an essentially cuboid contact bridge carrier 52, which is manufactured from a plastic. The cuboid shape extends along opening direction 40, and the two end faces are open in and against opening direction 40, so that contact bridge carrier 52 is hollow cylindrical. Receptacle 50, into which slide 48 is inserted in opening direction 40, is provided by means of one of the end faces. A return spring 54, which is supported on contact bridge 32 and a holder 55, protrudes through opposing end face. Holder 56 is formed by means of housing 14, so that return spring 54 is supported on housing 14.

Contact bridge 32 is supported on contact bridge carrier 52. For this purpose, contact bridge carrier 52, namely opposing longitudinal sides, has congruent guide slots 56 through which contact bridge 32 is guided, so that the latter has in each case a projection 58 on both sides of contact bridge carrier 52, i.e., perpendicularly to opening direction 40. One of projections 58 includes moving contact 36 and the other includes further moving contact 38. Due to the guide slot, it is possible to move contact bridge 32 in and against opening direction 40 relative to contact bridge carrier 52, whose position is predefined, for example, with the aid of drive 42, at least when slide 48 and contact bridge 32 are rigidly fastened to each other.

Slide 48, namely the part inserted into contact bridge carrier 52, and contact bridge carrier 52 each have an opening 60, which may be arranged congruently to each other, as illustrated in FIGS. 4 and 5. A rod is guided through the two openings 60 for rigid coupling. Contact bridge carrier 52 is thus also always moved with the aid of slide 48. However, it is also possible to remove the rod. A movement of contact bridge carrier 52 is possible only in opening direction 40 with the aid of slide 48. However, it is not possible to apply a force to contact bridge carrier 52 with the aid of slide 48 in the opposite direction. In this case, slide 48 is partially pulled out of receptacle 50, so that openings 60 are no longer congruent with each other. However, slide 48 always remains in receptacle 50 on the end side, for which reason contact bridge carrier 52 is guided on slide 48.

As a result, if the rod is not inserted, switching device 12 is designed in such a way that a force may be applied to contact bridge 32 only in opening direction 40 with the aid of electromechanical drive 42. To reduce costs, electromechanical drive 42 is also designed only in such a way that armature 44 may be moved therewith only in opening direction 40, for which reason electromechanical drive 42 is thus designed in such a way that force may be applied therewith to contact bridge 32 only in opening direction 40.

In summary, electromechanical drive 42 is thus connected to slide 48, and slide 48 and contact bridge carrier 52 are inserted into each other in opening direction 40. Slides 48 and contact bridge carrier 52 are only loosely inserted into each other when the rod has been removed. However, if the rod is inserted into openings 60, which are then arranged congruently to each other, they are fastened rigidly to each other. Drive 42 is permanently connected to contact bridge 32, to which a spring force is applied against opening direction 40 with the aid of return spring 54. Contact bridge 32 is also movably supported in opening direction 40 on contact bridge carrier 52, which is movably supported in opening direction 40. Electromechanical drive 42 is connected to contact bridge carrier 52.

When drive 42 is not in operation, i.e., is not supplied with current, contact bridge 32 is moved up to the stops of guide slots 56, due to return spring 54, so that an application of force to contact bridge carrier 52, and therefore also to slide 48, takes place. Due to the spring force, contact bridge 32 and armature 44 are thus moved, namely against opening direction 40. This continues to take place until moving contacts 36, 38 rest against fixed contacts 28, 30. This is regardless of whether the corresponding rod is inserted into openings 60. If the rod is present, it is also possible to move contact bridge carrier 52 and therefore also contact bridge 32 against opening direction 40 with the aid of drive 42. In this case, the assembly made up of slide 48 and contact bridge carrier 52 is moved against opening direction 40 with the aid of armature 44. The movement of contact bridge 32 also takes place, for example, with the aid of return spring 54 or only with the aid of drive 42.

To open mechanical switch 22, armature 44 is moved into opening position 40, so that slide 48 and contact bridge carrier 52 are also moved in opening direction 40. Contact bridge 32 is carried along with contact bridge carrier 52, so that it is also moved in opening direction 40, return spring 54 being compressed. The opening of mechanical switch 22 thus takes place only with the aid of the force applied by means of drive 42 against the spring force provided with the aid of return spring 54. In the example illustrated in FIGS. 4 and 5, a burn-off of moving contacts 36, 38 and fixed contacts 28, 30, which is induced by an arc formed therebetween, is compensated for with the aid of return spring 54 and the movable support of contact bridge 32 on contact bridge carrier 52.

One refinement of contact bridge carrier 52 is illustrated in FIG. 6 in a sectional representation along opening direction 40. Slide 48 remains the same, as does contact bridge 32 with the two projections 58. Contact bridge 32 is also still movably supported in guide slots 56. However, the end face of contact bridge carrier 52 opposite slide 48 is now closed, and return spring 54 is supported directly on contact bridge support 52 on the outside.

To pretension contact bridge 32, the latter is supported on contact bridge carrier 52 with the aid of a contact pressure spring 62. it is arranged within contact bridge carrier 52 between contact bridge 32 and the end face opposite slide 48 and extends in opening direction 40. In this example, a division of forces to be applied with the aid of the springs takes place. Contact pressure spring 62 is used primarily to compensate for the burn-off of moving contacts 36, 38 and fixed contacts 28, 30, while return spring 54 is used to close mechanical switch 22.

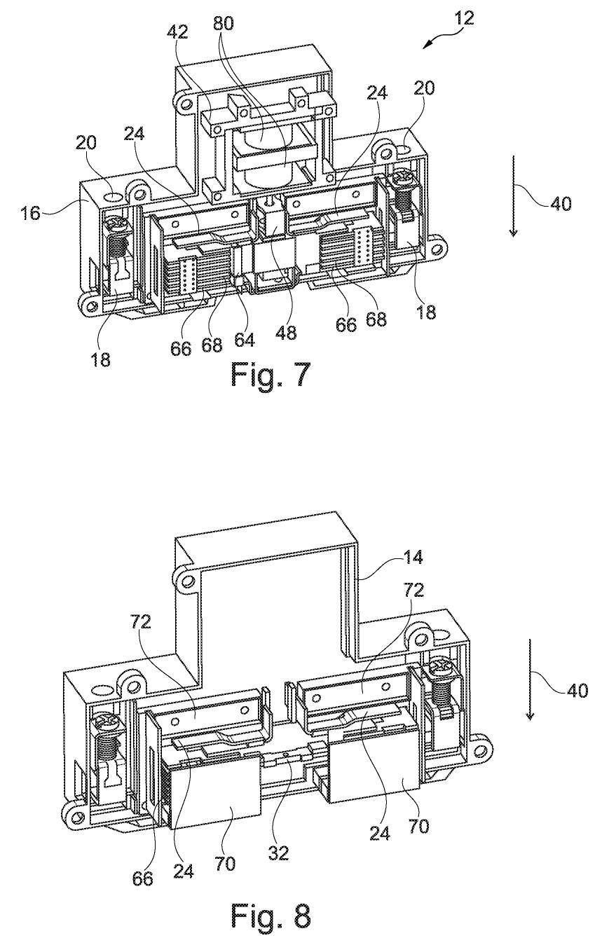

If a comparatively high electrical voltage is provided with the aid of DC voltage source 4, it is possible that an arc forms in each case between moving contact 36 and fixed contact 28 as well as between further moving contact 38 and a further fixed contact 30 during the opening of mechanical switch 22, so that an electrical current flow continues to exist between device connections 18. The arcs run essentially in parallel to opening direction 40, and a magnetic field thus forms around them. The latter are formed with the aid of two flux guide plates 64 oriented in parallel to opening direction 40. Flux guide plates 64 are made up of a ferromagnetic material, and complete bridge body 34 and therefore also the two moving contacts 36, 38 are therefore arranged therebetween, as is illustrated sectionally in a perspective view in FIG. 7. Flux guide plates 64 are fastened to contact bridge carrier 52 and are thus also moved with the aid thereof. Flux guide plates 64 are used to ensure that the magnetic fields forming around the two arcs merge with each other, so that the two arcs are surrounded thereby. The Lorentz force acting upon the particular arcs due to the magnetic field is intensified and directed in the direction of an arc chute 66 assigned in each case, which abut projections 58, so that contact bridge 32 is arranged between the two arc chutes 66.

Each arc chute 66 has multiple quenching plates 68 stacked one on top of the other and situated in parallel to opening direction 40. If the particular arc enters arc chute 66, it is pulled apart with the aid of quenching plates 68, so that a length is increased. A division also takes place, in part, with the aid of quenching plates 68. This results in that the electrical voltage needed to maintain the particular arc increases. When it exceeds the electrical voltage present between device connections 18, this arc collapses, for which reason the remaining arc also subsequently collapses. As a result, the electrical current flow over switching device 12 is interrupted.

To accelerate the movement of the arcs in particular arc chutes 66, each arc chute 66 has two blowout plates 70 in parallel to flux guide plates 64, between which particular quenching plates 68 are arranged. Each arc chute 66 also has a blowout magnet 72, which in the illustrated example is arranged above particular connection 24 against opening direction 40. A magnetic field running between quenching plates 68 is generated with the aid thereof and blowout plates 70, so that the movement of the arc in arc chute 66 is accelerated, which speeds up the quenching.

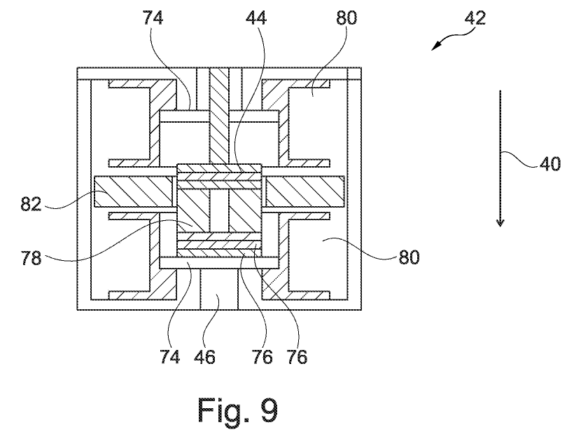

A sectional representation of drive 42 is illustrated in FIG. 9. It has armature 44 movably supported between two stops 74 in parallel to opening direction 40, whose opposing sides each have multiple annular wafers 76 stacked one on top of the other in parallel to opening direction 40. A cylindrical permanent magnet 78 is arranged therebetween. The two stops 74 are therefore made from different materials and thus have different magnetic properties. Stop 74 offset with respect to armature 44 against opening direction 40 is made from a paramagnetic or diamagnetic plastic, and the other is made from a ferromagnetic material. Armature 44 is thus connected to contact bridge 32 and movably supported between the two stops 74, which are manufactured from materials having different magnetic properties.

Drive 42 furthermore comprises two electrical coils 80, which are of the same design. The two electrical coils 80 are concentric to each other as well as offset from each other in opening direction 40. An annular shorting plate 82, which is arranged concentrically to electrical coils 80, is arranged between the two electrical coils 80. Drive 42 is thus designed as a moving magnet actuator.

When current is not supplied to electrical coils 80, the spring force directed opposite opening direction 40 and applied to contact bridge carrier 52, slide 48, and actuating rod 46 via contact bridge 32 with the aid of return spring 54 acts upon armature 44. Permanent magnet 78 is held in the region of shorting plate 82, due to the short-circuit of the magnetic field lines and the magnetic fields active between permanent magnet 78 and stop 74 offset in opening direction 40, which prevents a further movement of armature 44.

Once electrical coils 80 are supplied with current in the same direction, a comparatively strong magnetic field is generated, which interacts with the magnetic field provided with the aid of permanent magnet 78, which results in a movement of armature 44 in opening direction 40. This results in a compression of return spring 54, for which reason the force applied to contact bridge 32 against opening direction 40 with the aid of return spring 54 increases. However, the force of attraction between armature 44 and ferromagnetic stop 74 also increases, which compensates for the increase in the spring force. A comparatively fast movement of armature 44 is thus possible, and switching device 12 is designed in such a way that the compensation force acting against the spring force, due to the magnetic interaction of armature 44 with stops 74, acts upon contact bridge 32.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A switching device comprising:
a housing in which a mechanical switch is arranged, which has a contact bridge movably supported in an opening direction, which includes a moving contact and a connection with a fixed contact, the switch being designed such that, during a movement of the contact bridge in the opening direction, the moving contact is moved away from the fixed contact and, during a movement of the contact bridge against the opening direction, the fixed contact is approached;
an electromechanical drive connected to the contact bridge; and
a return spring via which a spring force is applied to the contact bridge against the opening direction.

2. The switching device according to claim 1, wherein the return spring is supported on the housing.

3. The switching device according to claim 1, wherein the electromechanical drive is designed such that, with the aid thereof, a force is adapted to be applied to the contact bridge only in the opening direction.

4. The switching device according to claim 1, wherein the contact bridge is movably supported in the opening direction on a contact bridge carrier, which is movably supported in the opening direction, and wherein the electromechanical drive is connected to the contact bridge carrier.

5. The switching device according to claim 4, wherein the return spring is supported on the contact bridge.

6. The switching device according to claim 1, wherein the return spring is supported on the contact bridge carrier, and wherein the contact bridge is supported on the contact bridge carrier via a contact pressure spring.

7. The switching device according to claim 4, wherein the electromechanical drive is fastened to a slide, and wherein the slide and the contact bridge carrier are inserted into each other in the opening direction.

8. The switching device according to claim 7, wherein the slide and the contact bridge carrier are loosely inserted into each other.

9. The switching device according to claim 4, wherein the contact bridge has a projection over the contact bridge carrier on both sides perpendicularly to the opening direction, wherein one of the projections has the moving contact, and the other projection has a further moving contact to which a further fixed contact is assigned, wherein two flux guide plates are fastened to the contact bridge carrier, which are oriented in parallel to the opening direction, and between which the moving contacts are arranged.

10. The switching device according to claim 1, wherein the electromechanical drive comprises an electrical coil and an armature, which is connected to the contact bridge and is movably supported between two stops, the two stops being manufactured from materials having different magnetic properties.

11. The switching device according to claim 10, wherein the switching device is designed such that a compensation force acting against the spring force acts upon the contact bridge due to a magnetic interaction of the armature with the stops.
